(19) United States
(12) Patent Application Publication
(10) Pub. No.: US 2013/0249870 A1
(43) Pub. Date: Sep. 26, 2013

(54) DUAL MODE ACTIVE STYLUS FOR WRITING BOTH ON A CAPACITIVE TOUCHSCREEN AND PAPER

(71) Applicants: Jiri Slaby, Buffalo Grove, IL (US); Roger W. Ady, Chicago, IL (US); William R. Groves, Naperville, IL (US)

(72) Inventors: Jiri Slaby, Buffalo Grove, IL (US); Roger W. Ady, Chicago, IL (US); William R. Groves, Naperville, IL (US)

(73) Assignee: MOTOROLA MOBILITY, INC., Libertyville, IL (US)

(21) Appl. No.: 13/426,860

(22) Filed: Mar. 22, 2012

(51) Int. Cl. G06F 3/033

(52) U.S. Cl. 345/179

(57) ABSTRACT

An active stylus writing apparatus for writing on a touch-sensitive interface and paper; including a conductive carrier coupled on a first end of the active stylus writing apparatus, and also coupled to internal circuitry for providing an active electrically charged capacitive field to inject a sufficient capacitive charge for writing upon the touch-sensitive interface. Additionally, the active stylus may include a removable compound end cap, typically comprised of at least two segments, the removable compound end cap configured to electrically couple to the conductive carrier when covering the conductive carrier on the first end of the active stylus writing apparatus, wherein the compound end cap is conductive in at least one segment and non-conductive in another segment.

### FIELD OF THE DISCLOSURE

The present disclosure relates generally to writing instruments for an electronic device having a touch-sensitive interface and more particularly to a writing stylus for writing both on an electronic device, including a capacitive touch-sensitive interface, and traditional paper.

### BACKGROUND

Today's users of mobile wireless communication devices and electronic signage boards that employ touchscreens as displays are required to use at least two writing instruments when the touchscreen interface has a capacitive sensing design, for example. One instrument is for writing on the touchscreen itself (e.g., a stylus), another is for writing off of the touchscreen (e.g., a pen or pencil), specifically on paper type products, such as note pads, composition books, daily planners, and tablets, for example. This dual necessity causes most users to remember to have both writing instruments in their possession during the day so that they are well-equipped for meetings, for example

Additionally, one or more embodiments may be useful in electronic devices that include a touch-sensitive interface, but may not be a communication device akin to a mobile wireless communication device. Therefore, the realized benefits of what's being proposed is not specifically limited to mobile wireless communication, and instead includes one or more electronic devices with touch-sensitive interfaces.

Capacitive touch-sensitive devices generally work by emitting a periodic waveform, such as a square wave or sine wave. When an object, like a user's finger, for example, comes in close proximity with the surface of the touch sensitive, the object disturbs electric field lines between the periodic waveform generator and receptor electrodes. A sensing circuit can detect this distortion as user input.

One solution has been utilizing a stylus with a thick tip for writing on a display with a capacitive touchscreen. These types of passive solutions (i.e., those that are devoid of any circuitry) require thick tips that are sized to mimic the capacitance effect of a human finger. However, the thick tip makes it difficult for a writer to determine his written strokes and/or other device interface requirements (e.g., screen selections, tracking for games, etc.) during the writing exercise, because of the density of lines resulting from the thick tipped passive stylus are larger on an order of magnitude. Consequently, selection of icons on a smaller display screen of a smartphone, for example, may be less than accurate.

Another solution can employ an active stylus (i.e., a stylus incorporating circuitry) in other applications different from capacitive sensing, such as acoustic, thermal, optical, or resistive applications. However, each of these applications are uniquely distinct from the capacitive sensing approach. Notably, capacitive approaches have significant advantages that manufacturers have come to appreciate, including spatial needs within mobile communication devices and less complexity in electronic chipsets than acoustic or thermal, for example. Capacitive touchscreens have become the desirable choice for manufacturers of devices inclusive of any touch-sensitive interfaces. Accordingly, there is a need for a dual-mode active stylus that enables a user to be able to write on a capacitive touchscreen and paper with a single instrument.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 exemplarily illustrates a dual mode active stylus in accordance with one or more embodiments.

FIG. 2 exemplarily illustrates an ink cartridge incorporated within the dual mode active stylus.

FIG. 3 exemplarily illustrates internal electronics in the dual mode active stylus.

FIG. 4 exemplarily illustrates a close up view of the writing tip portion of the dual mode active stylus.

FIG. 5 exemplarily illustrates segmented portions of the body of the retractable writing tip for the dual mode active stylus.

FIG. 6 exemplarily illustrates internal mechanisms for retractable writing tip for the dual mode active stylus.

FIG. 7 exemplarily illustrates external body for retractable writing tip for the dual mode active stylus.

FIG. 8 exemplarily illustrates ballpoint pen functions combined in a stylus tip for the dual mode active stylus.

FIG. 9 exemplarily illustrates one active stylus interacting with an electronic device having a touch-sensitive interface.

FIG. 10 exemplarily illustrates one active stylus configured to interact with a touch-sensitive interface.

FIG. 11 exemplarily illustrates a schematic block diagram of one active circuit suitable for use in a stylus.

FIG. 12 illustrates a stimulus received by a touch-sensitive device from a stylus that does not include an active circuit.

FIG. 13 illustrates a stimulus received by a touch-sensitive device from an active stylus comprised of electronic circuitry.

FIG. 14 illustrates two types of active styluses capable of coupling capacitively with a stylus user.

FIG. 15 illustrates the ability of a user to transfer from a paper writing surface to a touch-sensitive writing surface using one embodiment of the active stylus.

FIG. 16 illustrates the ability of a user to transfer from a paper writing surface to a touch-sensitive writing surface using another embodiment of the active stylus.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The dual mode active stylus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

An active stylus writing apparatus for writing on a capacitive touchscreen and paper is disclosed herein. The active stylus writing apparatus (hereinafter, “active stylus”) can include a conductive carrier that is coupled on a first end of the active stylus and that is also coupled and/or connected to internal circuitry for providing an active electrically charged capacitive field to simulate a human touch upon the capacitive touchscreen. The active stylus can also include a removable compound end cap, comprising at least two segments in one embodiment, for example, including a conductive segment. The removable compound end cap is configured to electrically couple to the conductive carrier when the end cap covers the conductive carrier on the first end of the active stylus. The compound end cap is conductive in at least one segment, such as at the cap tip; while the body of the end cap is non-conductive.

The active stylus disclosed herein offers several advantages. A clear advantage is that one writing instrument is useful for writing on touchscreen and paper. Therefore, there is no need to carry two writing instruments for users of a mobile communication device or of electronic office-type signage boards. The writing tip of the active stylus is smaller than the thick tip employed in passive style writing instruments for capacitive touchscreens, as well as for any other touch interfaces. As such, accuracy of selections of screen icons is greater and a user can easily discern their own writing strokes. Additionally, an active stylus may function without the need for direct contact to the touch screen corresponding to the tuning of the capacitive touch-sensitive interface; thereby, allowing sensing of gestures and depth sensing capabilities.

Embodiments of the present invention provide an active stylus configured for interaction with a touch-sensitive interface such as interface employing a capacitive touch sensor. The term “active” is used herein to refer to circuit components within the stylus that are powered by an electrical energy source, such as a battery or other power supply. Examples of active components include integrated circuits, operational amplifiers, comparators, buffers, inverters, and the like. This contrasts with “passive” components that do not require an energy source, examples of which include capacitors, resistors, inductors, and transmission lines.

The active styluses described herein include an active circuit and one or more electrodes. For example, a center electrode and a shroud electrode, disposed concentrically about the center electrode, are operable with an active circuit to “inject” charge into sensors disposed within a touch-sensitive display or interface. The injection of charge works to increase, or in some complementary embodiments decrease, the effective capacitance presented to a capacitively-enabled touch-sensitive device.

The electrodes of styluses described herein are configured to inject charge through a Miller capacitance created between the electrodes and the touch-sensitive device. Miller capacitance can be undesirable in some active circuits, in that it can compromise gain. However, when used in accordance with embodiments of the present invention, it works to increase (or in complementary embodiments decrease) the capacitive coupling between the stylus and the touch-sensitive display. It however needs to be noted that the art disclosed will work with other capacitive stylus approaches; i.e., not only w/ Miller effect based ones.

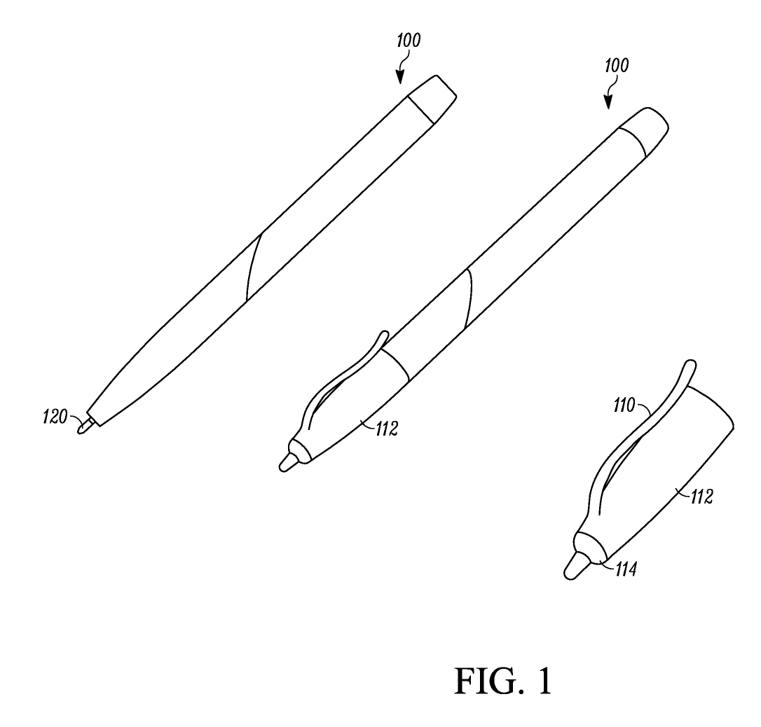

FIG. 1 exemplarily illustrates a dual mode active stylus 100. The dual mode active stylus 100 can be used to write on capacitive touchscreens that are deployed in mobile communication device displays. Mobile communication devices can include, for example, smartphones, tablet computing devices, and electronic reading devices, referred to as e-readers. Other electronic devices that employ capacitive touchscreens, for example, electronic office-type signage boards or any other touch interface that can receive input information via a stylus will benefit from the active stylus 100. Active stylus 100 includes a conductive carrier coupled on a first end of the active stylus writing apparatus, and also coupled to internal circuitry for providing an active electrically charged capacitive field to simulate a human touch upon the capacitive touchscreen. The conductive carrier may be configured to retain ink, pencil lead, light, or be formed by lead, for example. Another exemplary device may be a pointer combined with a capacitive stylus that is incapable of functioning as a writing device. The conductive carrier may be formed of metal or semi-conductive material.

Active stylus 100 includes a removable end cap 110 for protecting a ball point writing tip 120, which is mechanically and electrically coupled to active stylus 100. Removable end cap 110 also is equipped with a compound writing tip on the closed end of the cap (also referred to herein interchangeably as “compound writing cap tip” and “cap tip”). The compound writing cap tip is conductive and functional for writing on capacitive touchscreen surfaces. The cap tip may have many shapes, not only the depicted one. For example, the cap tip can employ a conventional bullet type shape.

Removable end cap 110 provides protection for the ball point writing tip 120 when removable cap 110 covers the ball point writing tip and is adjoined to active stylus 100. Removable end cap 110 is segmented into at least two sections, a non-conductive section 112 and a conductive section 113. Non-conductive section 112 isolates a ground connection corresponding to the user's position relative to Earth (i.e., user's ground) from conductive section 113. Conductive section 113 enables the capacitive touch screen interaction and writing function of the active stylus 100 upon the capacitive touch screen. The conductive section 113 provides an active electrically charged capacitive field to simulate a human touch upon the capacitive touchscreen. The conductive section may be made of elastomer, plastic, metal, or a combination thereof. The capacitive touchscreen is protected from scratches or other unwanted marks that may be attributed to the ball point pen writing tip 120 of the active stylus 100. Specifically, the removable cap 110 also protects the capacitive touchscreen from ink and metal shavings dispersed by ball point writing tip 120.

One embodiment may employ an end cap tightness notification means including one or more of the following: an audible click, a color change, and gel expansion within the removable end cap. The compound cap tip 114 may be in direct contact w/ the writing tip 120, or alternatively, in proximity of the writing tip 120; in which case electrical charge is transferred via capacitance. The compound cap tip 114 may be formed of many shapes, including the conventional bullet type shape as already noted. The compound cap tip 114 can be coated with or comprised of metallic particles to enhance conductivity.

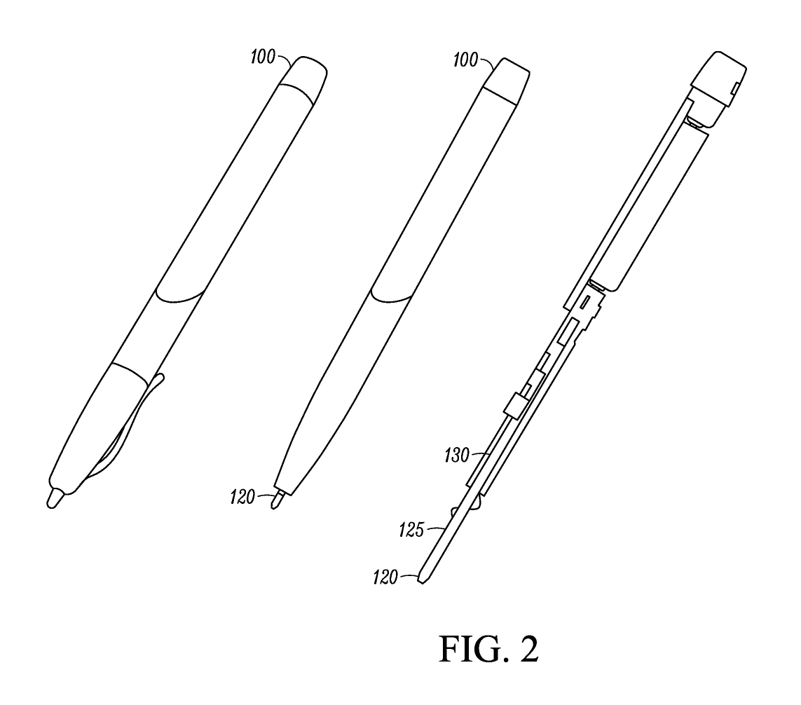

FIG. 2 illustrates an internal view of ball point writing tip 120 within active stylus 100. Ball point writing tip 120 is comprised of an elongated ink cartridge 125 of a predetermined diameter for residing within active stylus 100 along with a printed circuit board (PCB) 130 for active stylus 100. One embodiment uses an ink cartridge having a writing tip of less than 2.5 millimeters. Design choices for length and diameter of the elongated ink cartridge 125 are many. Additionally, the size of PCB 130 can be varied as well to accommodate elongated ink cartridge 125 within the housing of active stylus 100. PCB 130 is directly connected to the ink cartridge to provide a necessary electrical charge; however, there may be configurations where the electrical charge could be transferred by other means, such as a capacitive means.

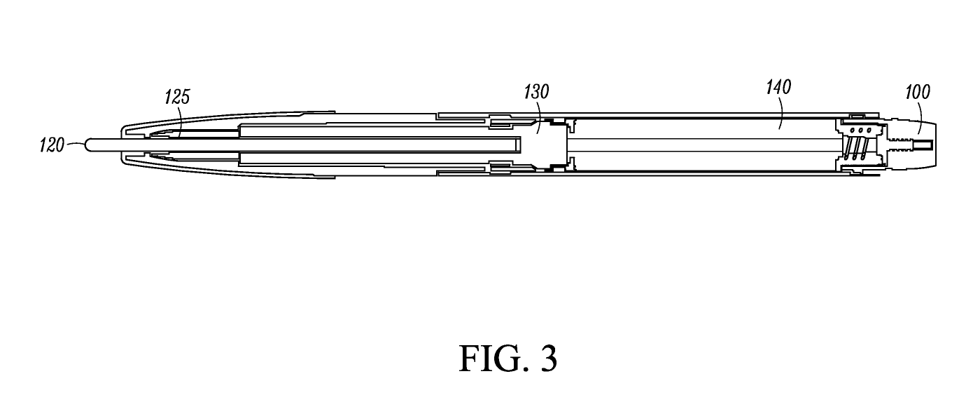

FIG. 3 exemplarily illustrates additional internal components for active stylus 100. Active stylus 100 can include within its housing an ink cartridge 125 having a ball point writing tip 120; a PCB 130 having control electronics and circuitry for enabling active stylus 100 to interact with a capacitive touchscreen; and a power supply 140, which can be a battery, a solar panel, nano-electronics, a micro-electro mechanical grating system, or a piezoelectric element, for example.

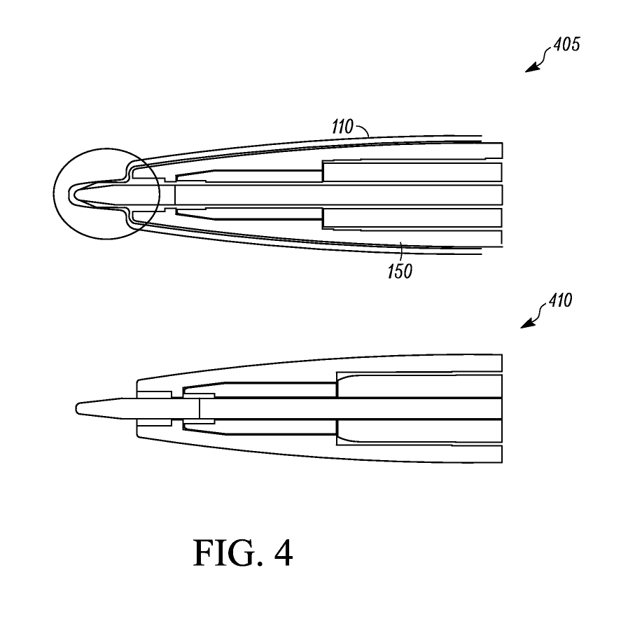

FIG. 4 exemplarily illustrates one end of active stylus 100 having a stylus housing 150 in a capped mode 405, wherein the removable cap 110 is providing protection to ball point pen writing tip 120. The ball point pen writing tip 120 resides firmly within removable cap 110. Removable cap 110 includes a conductive section 113 on the closed end of the removable cap to enable capacitive touchscreen writing and interaction. FIG. 4 also shows the same end of active stylus 100 in an uncapped mode 410, wherein the ball point writing tip 120 is uncovered and lacks the protection of removable cap 110. The internal circuitry in the conductive carrier is selectably controllable by covering the first end of the conductive carrier with the removable end cap.

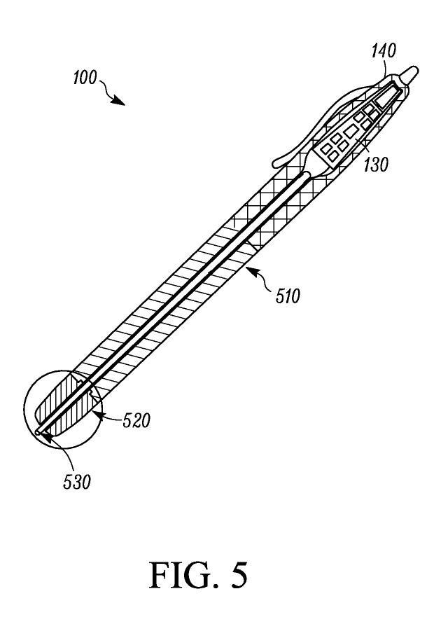

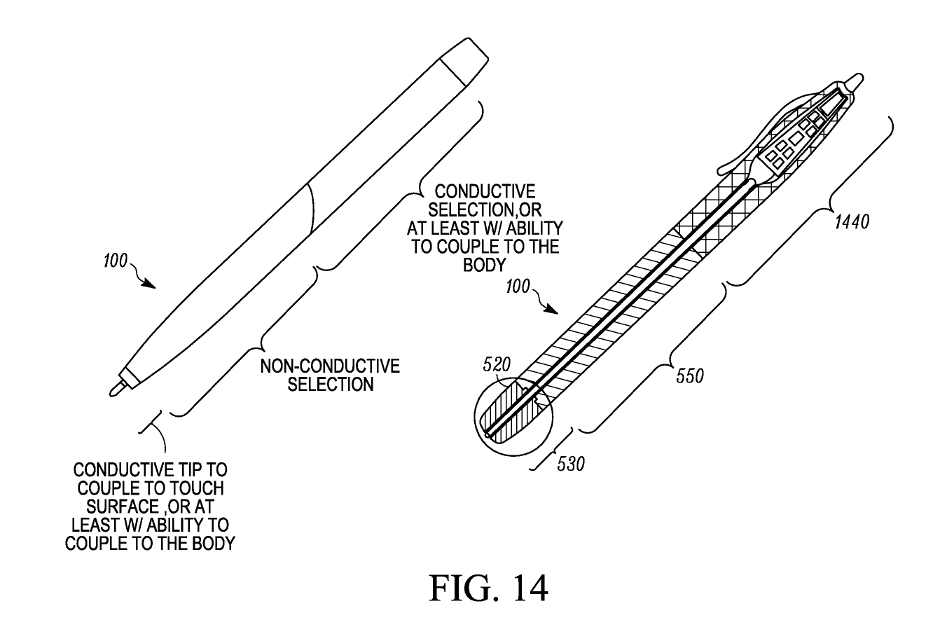

FIG. 5 exemplarily illustrates another embodiment for active stylus 100. For example, active stylus 100 may include an electrically non-conductive body 510 or housing coupled to an electrically conductive tip 520 that holds an electrically conductive ink cartridge or lead 530; wherein the ink cartridge or lead 530 is capable of protruding from the end of the tip 520 of active stylus 100; and the end of the active stylus 100 is equipped or formed to function as a writing tip 520. Internal to active stylus 100 is a power supply 140 on the far end of the active stylus 100 in relation to the tip of the active stylus 100. The power supply may be coupled directly or indirectly to an electronics circuitry 130. There exists a coupling from the ink cartridge to a conductive tip 520 for enabling capacitive touchscreen writing/interaction. An electro-conductive elastomer, plastic, metal, or their combination may be used for the conductive tip 520 to cause electrical coupling between the conductive carrier 1440 (further shown in FIG. 14) of the active stylus and the conductive tip 520. The conductive tip 520 can be coated with or comprised of metallic particles to enhance conductivity.

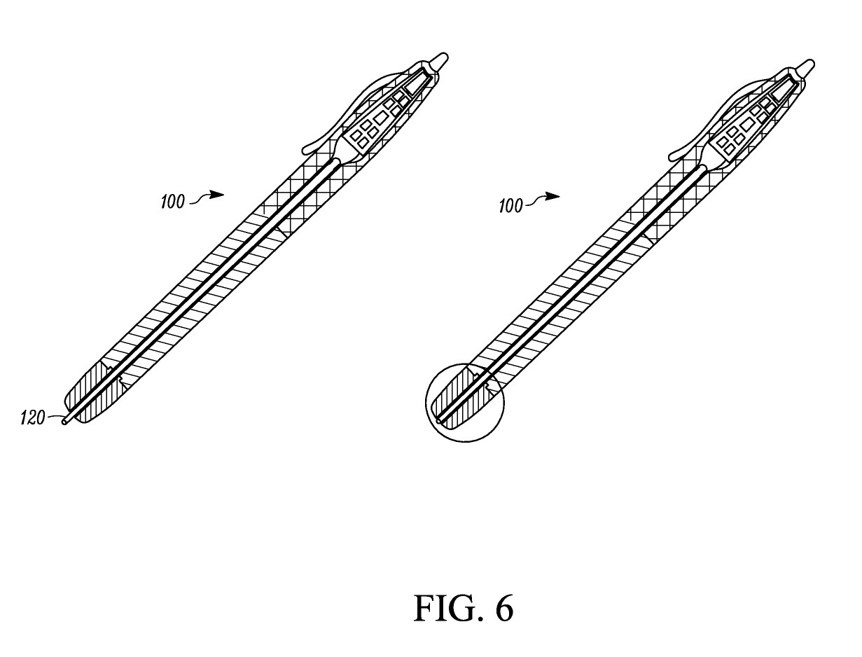

FIG. 6 exemplarily illustrates internal mechanisms for retractable writing tip for another embodiment of the dual mode active stylus. Active stylus 100 may include a retractable writing tip 120 comprised of a paper writing tool, such as an ink cartridge or pencil lead cartridge. Any well-known means of retracting the cartridges can be employed to form a retractable conductive carrier, for example a touch sensor, push-push mechanism, rotational mechanism, and other typical approaches for retractable ink cartridges. The same means of retracting or deploying the ink or pencil lead cartridges may be used to control the power circuitry of the active stylus 100, i.e., turning the active stylus 100 off or on.

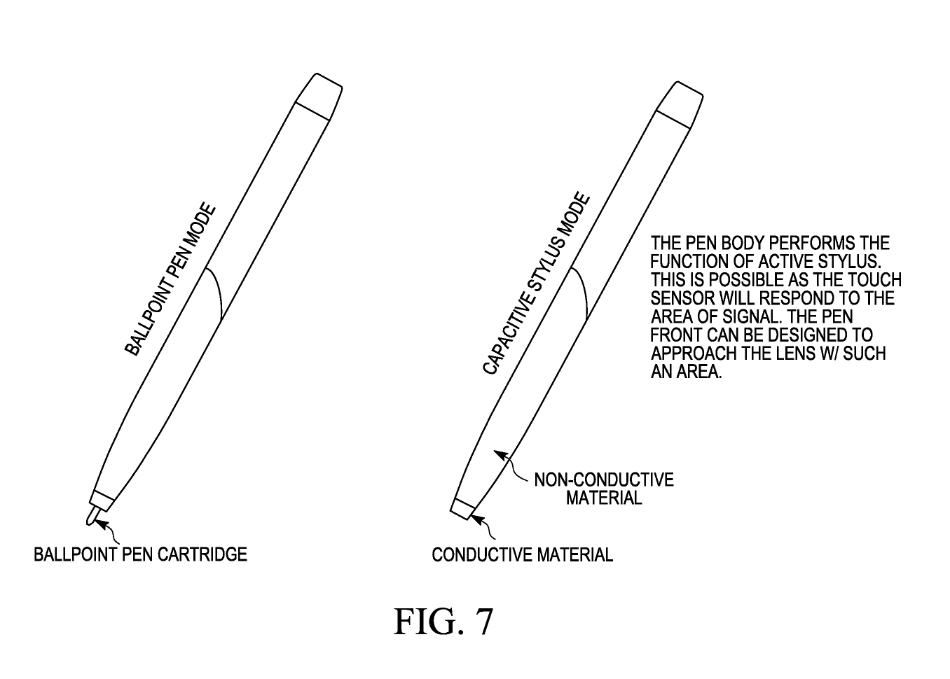

FIG. 7 exemplarily illustrates views of the external body for retractable writing tip for the dual mode active stylus 100. In this embodiment, the body or housing of the active stylus 100 performs the function of interacting with a capacitive touchscreen by utilizing a touch sensor (not shown) near one end of the active stylus 100.

Another embodiment of the dual mode active stylus 100 utilizes the writing tip 120 of an ink cartridge 125, for example, as also a stylus tip for the capacitive touchscreen. Writing tip 120 directly touches the capacitive touchscreen when an internal touch sensor is activated. Special ink formulations may be used to provide ink that does not leave any undesirable marks on the capacitive touchscreen. In this embodiment, there is no need for a removable cap 110 or for the ball point writing tip 120 to retract.

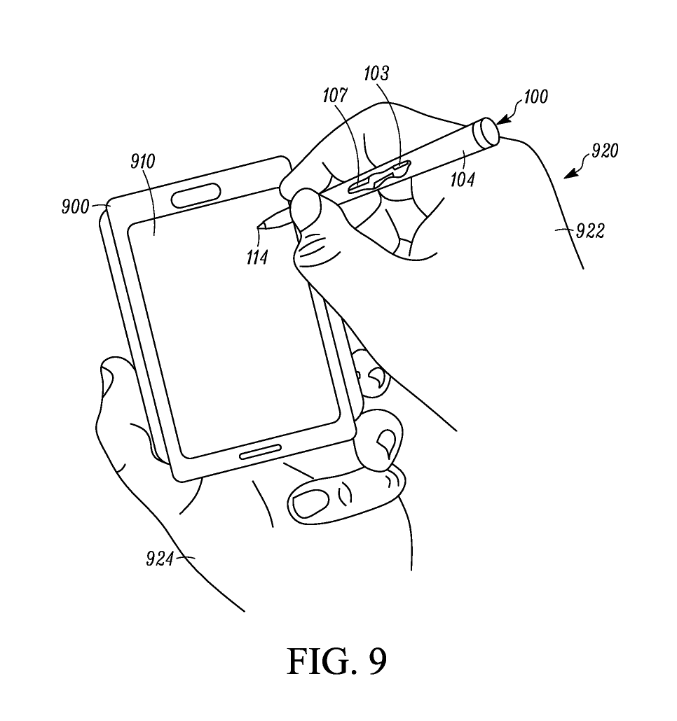

FIG. 9 exemplarily illustrates the stylus of FIG. 1 being used with an electronic device 900 that includes a touch-sensitive interface 910. The illustrative touch-sensitive user interface 910 is a capacitive touch-sensitive user interface, although other technologies are contemplated and may be used. Capacitive touch-sensitive devices include a plurality of capacitive sensors, e.g., electrodes, which are disposed along a substrate. Each capacitive sensor is configured, in conjunction with associated control circuitry, to detect an object in close proximity with-or touching-the surface of the electronic device 900 by establishing electric field lines between pairs of capacitive sensors and then detecting perturbations or changes of those field lines. The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems, because it is transparent and conductive. Further, it is capable of being deposited in thin layers by way of a printing process. The capacitive sensors may also be deposited on the substrate by electron beam evaporation, physical vapor deposition, or other various sputter deposition techniques.

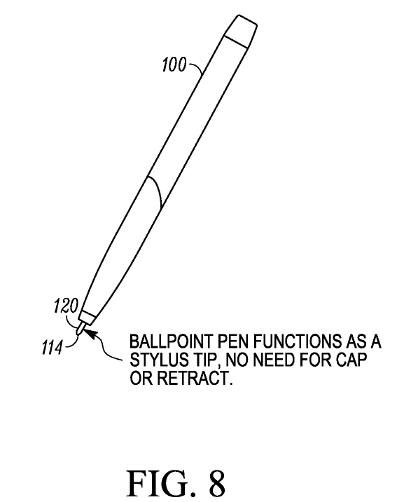

A user 920 provides an electrical return path between the stylus 100 and the electronic device 900 as follows: Both the stylus 100 and electronic device 900 are capacitively coupled to the user 920 through the user's hands 922, 924. The user 920 is also capacitively coupled to earth ground. This capacitive return to earth ground provides a reference point from which the compound tip 114 can inject charge into the touch-sensitive interface 910. The compound tip 114 may be inclusive of the end cap 110 shown in FIG. 1 or may be a part of the cartridge 125 as shown in FIG. 8. While a user 920 is shown holding the stylus 100 in FIG. 9, this need not be the case for the stylus 100 to work. Said differently, the stylus 100 also works when the electronic device 900 is somewhere other than in the user's hand 924. For example, if the electronic device 900 were sitting on a non-conductive surface such as a wooden table rather than in the user's hand 924, even though there is no direct return path to earth ground through the user's hand 204 and body in this instance, the wooden table and surrounding environment would still provide sufficient coupling to earth ground for the stylus 100 to work.

In the configuration shown in FIG. 9, the compound tip 114 “sniffs” electric field variations emitted from the touch-sensitive interface 910. The active circuit of the stylus 100 applies gain, which in one embodiment is inverting and amplifying, and injects charge into the touch-sensitive interface 910 to alter the capacitance formed between the touch-sensitive interface 910 and the compound tip 114. An advantage offered by the stylus 100 is that the electronic device 900 need not be configured with special software or application specific hardware components to detect the stylus's compound tip 114. The Miller capacitance formed between the compound tip 114 and the touch-sensitive interface 910 works to increase the capacitive coupling between a signal source embedded within the electronic device 900 and the dynamic node of the compound tip 114.

In one embodiment, the stylus 100 is configured with an energy harvesting circuit 105. Since the power required to run the active circuit is relatively small, in a stylus having advanced power management the energy harvesting circuit 105 can be configured to draw power from the received electric field variations by way of capacitive coupling circuitry. In another embodiment, where the stylus includes a power supply 140, such as a battery (exemplarily shown in FIG. 3), the energy harvesting circuit 105 can be configured to periodically charge the battery, thereby extending its operable life. Alternate methods of harvesting energy may use a mechanical strain component or a heat sensor configured to absorb heat from the user's hand 922, for example. In yet another embodiment, the stylus 100 can be configured with a micro-USB connector for harvesting power.

In one or more embodiments, the compound tip 114 is configured with a sensor, such as an optical sensor, mechanical sensor, or switch. In one embodiment in which the compound tip 114 may employ a center electrode, the sensor can be configured to detect the center electrode that comes directly in contact with, or very close to, the touch-sensitive interface 910. In one or more embodiments, the sensor can be used to actuate the active circuit when the sensor detects that the center electrode is close to or directly in contact with the touch-sensitive interface 910. Further, the sensor can be used to deactivate the active circuit when, or after, the stylus 100 is removed from the electronic device 900.

In yet another embodiment, the stylus 100 includes a communication circuit 107 configured for communicating with a corresponding communication circuit disposed within the electronic device 900. Examples of suitable communication circuits include Bluetooth, infrared, magnetic field modulation, acoustic, and Wi-Fi circuits.

The ability for the stylus 100 to communicate with the electronic device 900 enables the stylus 100 to obtain real-time phase information for scanning purposes. Rather than this information being detected by the compound tip 114, it can be obtained from the communication circuit 107. Where the communication circuit 107 is included, the communication circuit 107 provides dual-mode functionality in that one function of the stylus 100 can be initiated with charge injection from the compound tip 114, while another is initiated by the communication circuit 107.

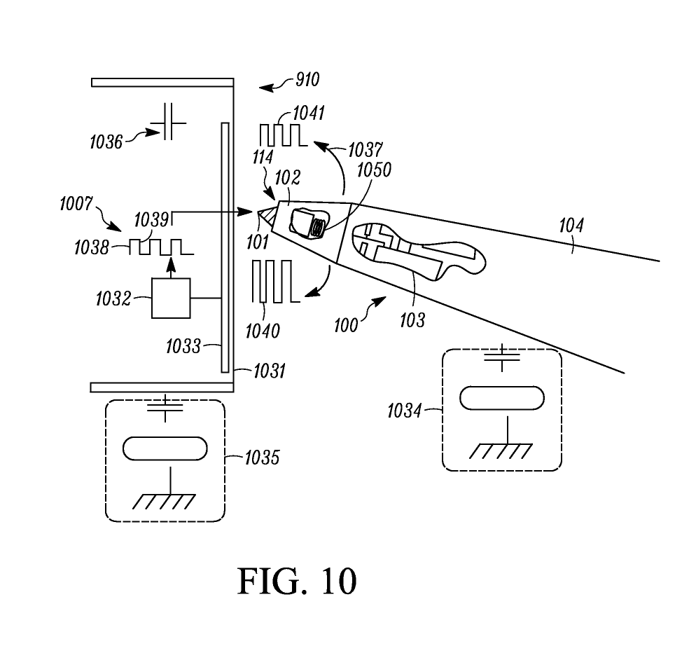

FIG. 10 exemplarily illustrates a sectional view of one embodiment of the stylus 100 interacting with one embodiment of touch-sensitive interface 910. The touch-sensitive interface 910 includes a touch-sensitive surface 1031. A signal generator 1032 generates a periodic waveform 1007, which can be a square wave, sine wave, triangle wave, or other periodic waveform. The periodic waveform 1007 establishes an electric field between the signal generator 1032 and an array 1033 of receive electrodes. Circuits 1034 and 1035 represent the capacitive coupling to earth ground provided by the user's hands (922, 924) in FIG. 9.

When the compound tip 114 of the stylus 100 is brought into close proximity with the touch-sensitive surface 1031, a Miller capacitance 1036 is formed between the compound tip 114 and the touch-sensitive interface 910. The center electrode 101, which works here as a receive electrode, detects the electric field variations 1007. The active circuit 103 then applies gain to the detected field variations and injects 1037 charge into the touch sensitive interface 910 by varying a potential of the end cap 110 or alternatively the concentrically aligned shroud electrode 102, which works here as a transmit electrode. In one embodiment, the injection of charge occurs synchronously with the electric field variations detected by the receive electrode of the compound tip 114.

In the illustrative embodiment of FIG. 10, the periodic waveform 1007 comprises positive transitions 1038 and negative transitions 1039 that establish electric field variations between the signal generator 1032 and the array 1033 of receive electrodes. The active circuit 103 can be configured to respond to these transitions in a variety of ways. For example, the active circuit 103 can be configured to inject 1037 charge only on a predetermined sequence of transitions. In one embodiment, the active circuit 103 is configured to inject 1037 charge only on the positive transitions 1038. In another embodiment, the active circuit 103 is configured to inject 1037 charge only negative transitions 1039. In another embodiment, the active circuit 103 is configured to inject 1037 charge only on every other positive transition 1038.

Different responses to the electric field variations 1007 can be used to modify the charge injection 1037 so that the stylus 100 responds to some events while ignoring others. For instance, one implementation might inject negative charge after detecting a rising edge, and then inject negative charge after detecting the immediately following falling edge. Upon the next pair of rising and falling edges occurring, the compound tip 114 could be configured not to inject charge. In this way, the touch-sensitive interface 910 can distinguish the stylus 100 form a user's finger.

In one embodiment, the stylus 100 is configured with an optional force sensor 1050. By changing the impedance of the electrical pathway between the active circuit 103 and either one or both of the center electrode 101 and shroud electrode 102 in response to force, it is possible to change the magnitude of the capacitive coupling by a corresponding amount.

In the illustrative embodiment of FIG. 10, the force sensor 1050 is shown as a mechanical force sensor, such as a spring, disposed between the center electrode 101 and the stylus body 104. The force sensor 1050 can be used to activate the active circuit 103 when the center electrode 101 is in contact with the touch-sensitive interface surface 331. In another embodiment, the active circuit can use output information from the force sensor 1050 to alter the magnitude of the injected charge as a function of forces detected by the force sensor 1050. Accordingly, a user may be able to draw darker lines, for example, by applying more pressure.

It will be clear to those of ordinary skill in the art having the benefit of this disclosure that other sensors could be used with, or substituted for, the force sensor 1050. Examples of these sensors include a switch, communication circuit, nano sensing technology, micro-electro mechanical systems, or an optical sensor. Additionally, piezoresitive elements may be disposed between the stylus body 104 and the center electrode 101. In any of these embodiments, the force sensor 1050 enables the stylus 100 to deliver a varying capacitance based upon detected, applied force. This capability is well suited for applications such as signature recognition, in which user-applied force is a measurable biometric.

In one embodiment, the stylus 100 is configured to deliver a slant detection indication to the touch-sensitive interface 910. This best illustrated by way of example. As shown in FIG. 10, the stylus 100 extends from the touch-sensitive surface 1031 at a downward angle. At the same time, the shroud electrode 102 has a conical shape. When the active circuit 103 injects 1037 charge, the lower side of the shroud electrode 102 is closer to the touch-sensitive surface 1031 than the upper side. Consequently, the charge 1040 injected by the lower side is greater than the charge 1041 injected by the upper side. The array 1033 of sensor electrodes with the touch-sensitive interface 910 can be configured to interpret this as a slant detection indication, and can use this information in manipulation of objects presented on the touch-sensitive interface 910. The conical shape of the shroud electrode 102 ensures that the slant detection indication is linearly increasing as the stylus 100 is further inclined.

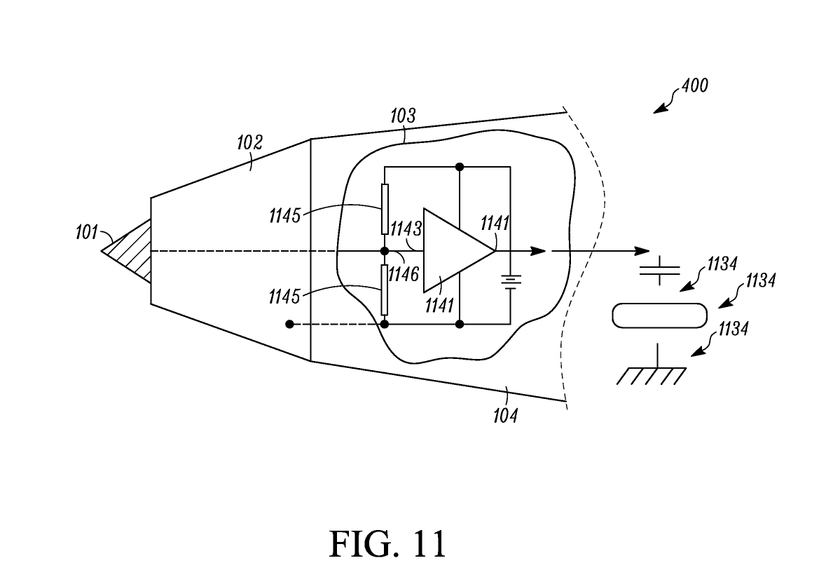

FIG. 11 exemplarily illustrates a schematic block diagram of one illustrative active circuit 103 configured in accordance with one or more embodiments of the invention. As shown in FIG. 11, the active circuit 103 comprises a buffer 1141 powered by a voltage source 1142. The buffer 1141 has an input 1143 that is coupled to the center electrode 101. An output 1144 of the buffer 1141 is coupled to the shroud electrode 102. In the illustrative embodiment of FIG. 11, the gain of the buffer 1141 is negative such that rising edges detected by the center electrode 101 corresponds to negative charge injection by the shroud electrode 102.

A voltage divider 1145 is coupled across the voltage source 1142, with a central node 1146 of the voltage divider 1145 coupled to the input 1143 of the buffer 1141. In one embodiment, the voltage divider 1145 is configured such that the potential established at the central node 1146 is set at a transition-threshold level of the buffer 1141. This transition-threshold level is the voltage at which the output 1144 toggles from an active high state to an active low state or vice-versa. In one embodiment, the output 1144 of the buffer 1141 is coupled to the stylus body 104. In this embodiment, circuit 1134 represents the coupling of the stylus body 104 to earth ground by way of the user's hand.

Referring again to FIG. 10, when the center electrode 101 detects a rising (positive) edge 1038 or a falling edge 1039 from the touch-sensitive interface 910, the buffer 1141 toggles and changes the potential of the shroud electrode 102. In the configuration of FIG. 11, negative charge is injected into the touch-sensitive interface 910 when a rising (or positive-going) edge is detected by the center electrode 101. Likewise, a positive charge is injected into the touch-sensitive interface 910 when a falling (or negative-going) edge is detected by the center electrode 101. This “bang-bang” action on rising and falling edges enhances the capacitive coupling between the compound tip 114 and the touch-sensitive interface 910.

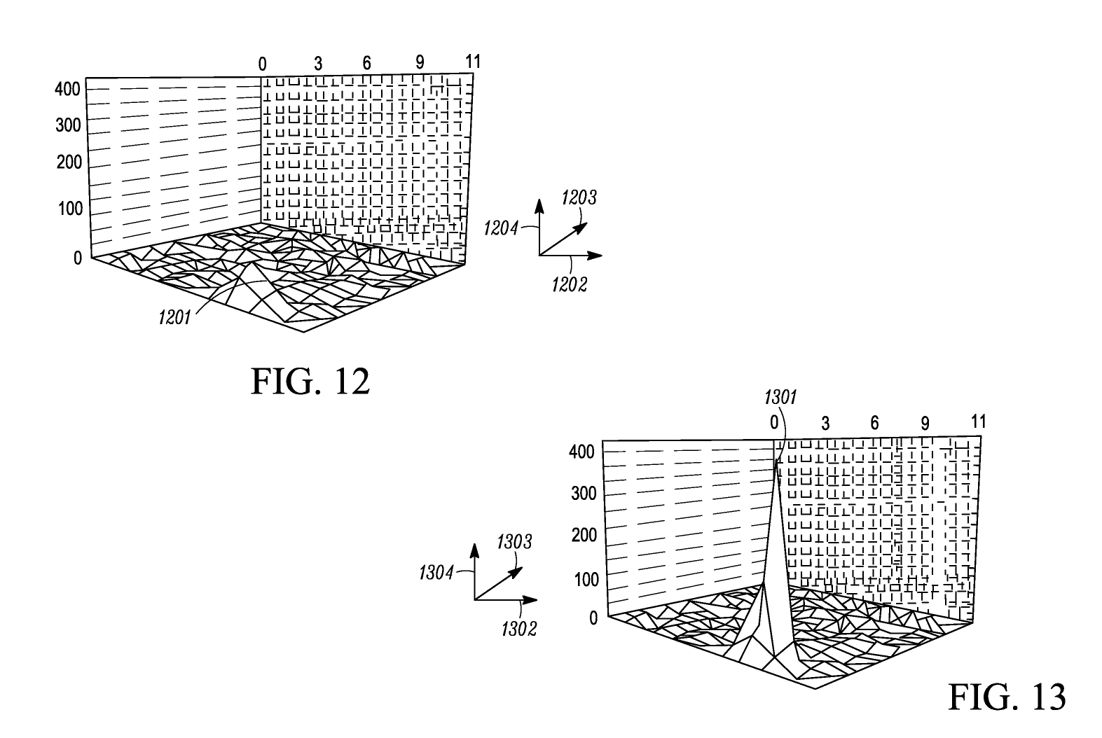

FIGS. 12 and 13 illustrate the charge detected by a stylus that does not include an active circuit coming into contact with a touch-sensitive interface, and a stylus configured in accordance with one or more embodiments disclose herein, respectively. In each figure, horizontal axes 1202, 1203 and 1302, 1303 represent the planar surface area of a touch-sensitive surface, while the vertical axes 1204, 1304 represent the magnitude of detection signals along that planar surface area.

Most prior art styluses either require advanced hardware and software in both the stylus and receiver, or are simply mechanical devices having no active circuitry. FIG. 12 shows a charge detection peak 1201 of the latter, i.e., a fine-tipped stylus having no active circuit. Passive devices provide small touch signals, similar to that shown in FIG. 12. The actual signal delivered will change minutely based upon the width of the stylus tip.

By sharp contrast, the charge detection peak 1301 of embodiments disclosed herein is shown in FIG. 13. As shown, it is orders of magnitude higher than those presented by passive prior art styluses. Further, the compound tip of embodiments of the present invention can configured as a finer point, such as with a 2.5 millimeter center electrode or end cap writing tip, thereby closely resembling a ballpoint pen.

FIG. 14 illustrates two different type of styluses 100. One stylus may be capped. The second stylus is retractable. However, both styluses 100 include a conductive section 1440 that enables the stylus to be capacitively responsive (i.e., “coupled”) to the body of a stylus user as the user engages with the stylus during writing. Notably, not all sections of stylus 100 need to be fully conductive, especially with strong tuning capabilities. Additional sections of stylus 100 were previously described above and include a non-conductive section 510, a conductive tip 520 (for either coupling to an ink cartridge or a touch-sensitive interface or a stylus user's body during writing), and a conductive ink or lead cartridge 530.

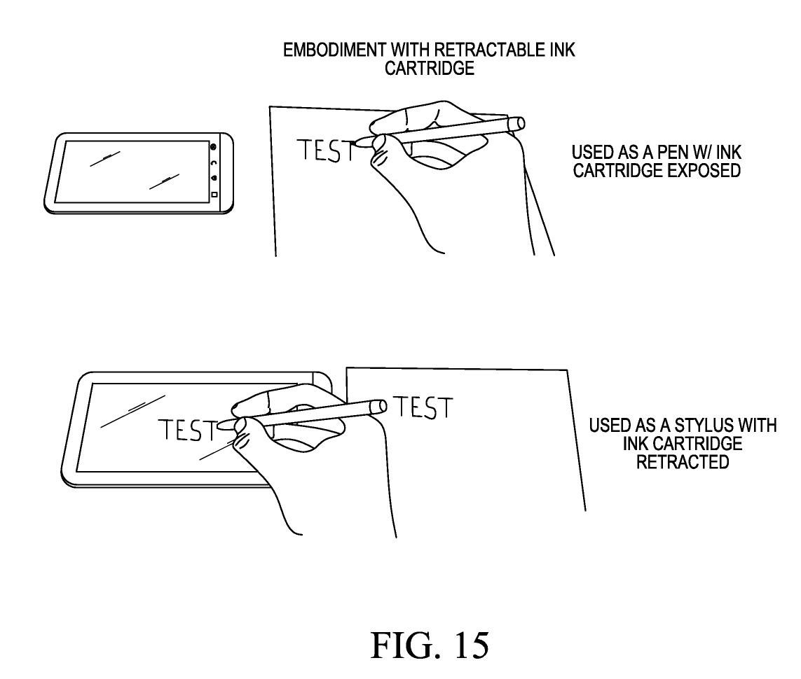

FIG. 15 illustrates the ability of a user to transfer from one writing surface such as a pad of paper to a second writing surface having a touch-sensitive interface while using a single writing instrument. The active stylus shown is a retractable type embodiment, wherein to write on paper the ballpoint pen tip as a part of an ink cartridge is exposed. The ink cartridges can be multi-colored. To write on or engage with or interact with a touch-sensitive interface on an electronic device, the user retracts the exposed ballpoint pen writing tip and instead uses the electrically conductive writing tip surrounding the ballpoint pen tip and that includes an opening for the ballpoint pen tip to enter and exit during upon control to retract pen or not. Control for retraction of ballpoint pen tip may be mechanical, optical, or electrical.

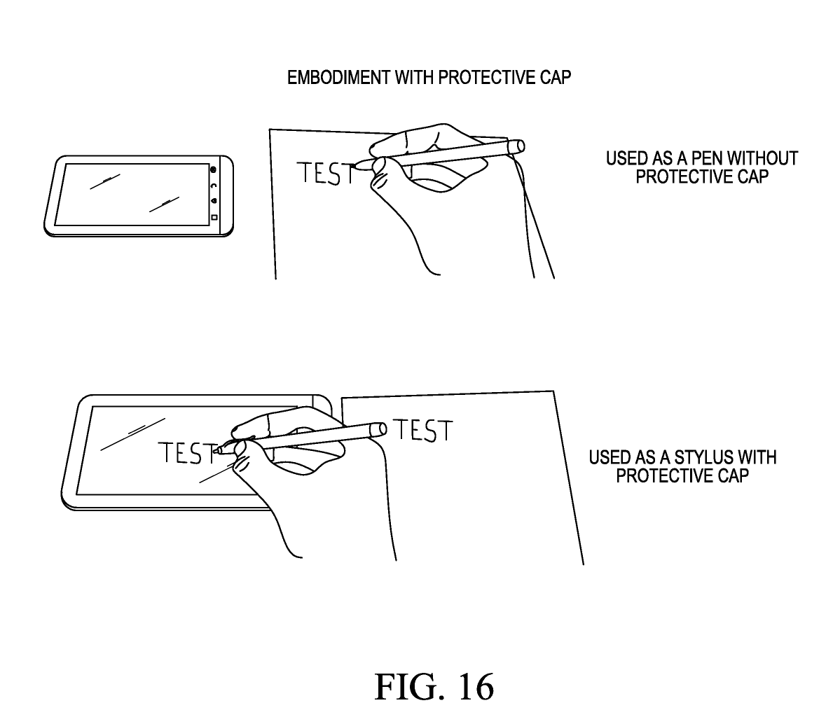

FIG. 16 illustrates the ability of a user to transfer from one writing surface such as a pad of paper to a second writing surface having a touch-sensitive interface while using a single writing instrument. The active stylus shown employs a removable end cap type embodiment, wherein to write on paper, the ballpoint pen tip as a part of an ink cartridge is exposed once the protective pen cap is removed from the end of the writing tip. The ink cartridges can be multi-colored. To use this embodiment to engage or interact with a touch-sensitive interface, a user places the protective end cap over the ballpoint pen writing tip and uses the protective end cap to write characters.

One embodiment of an active stylus enables a method for configuring the active stylus to write on paper and also an electronic touch-sensitive interface. The method includes detecting an electric field variation associated with a conductive carrier that is configured to retain ink or pencil lead in a cartridge; and applying a gain, with a circuit that is internal to the active stylus, to a signal corresponding to the electric field variation. The method also includes injecting charge from the internal circuit of the active stylus to the cartridge; and coupling the cartridge to a conductive segment of a removable compound end cap.

Another embodiment of an active stylus enables a method for configuring the active stylus to write both on paper and an electronic touch-sensitive interface, wherein the method includes detecting an electric field variation with a conductive carrier that is configured to retain a pen or pencil lead in an electrically conductive cartridge and applying a gain, with a circuit that is internal to the active stylus, to a signal corresponding to the electric field variation. The method also includes injecting charge from the internal circuit of the active stylus to the electrically conductive cartridge; and coupling the electrically conductive cartridge to a conductive tip of the pen or pencil lead.

The various embodiments described herein offer numerous advantages over prior art solutions. For instance, “gloved hand” operation is generally not supported by most touch-sensitive interfaces. The various styluses described herein permit gloved-hand operation. Additionally, while shown illustratively herein as a stylus, embodiments of the invention could also be configured as thimbles suitable for user wear under a glove, for incorporation into one or more fingertips of a glove, or other configurations. In any configuration, embodiments described herein increase capacitive coupling—even when the user is wearing gloves—so that the touch-sensitive interface can detect touches of the stylus.

Additionally, embodiments of the present invention provide stylus interaction that appears, to the touch-sensitive interface, as a “finger-touch.” In so doing, the styluses described herein can be used in conjunction with fingers to perform multi-finger gesture operations.

The several novel and inventive protective removable cap and retractable pen/pencil embodiments described above for an active stylus substantially differ from conventional protective caps for passive styluses. One difference can be in the material selection. Another difference can be in the ink cartridge proximity to the cap and writing tips or nubs of the stylus. For example, the protective cap for a passive stylus needs to be fully conductive, so that the stylus couples to the user's body. In addition, the protective cap tip typically needs to be comprised of conductive compliant material (such as elastomer) to be “visible” to a touch-sensitive interface, like a touchscreen, when pressure is applied (that is the tip gets compressed to create a larger contact area upon the surface of the touch-sensitive interface). The conductive areas of the passive stylus are connected to transfer the signal from the user's body to the touch screen. Alternatively, if the tip is made of solid material, it may require a large flat area for contacting the surface of the touch-sensitive interface. In addition, there is no concern about proximity between the ink cartridge and the protective cover cap tip or its other sections. All interface signals are conducted via the protective cap.

In sharp contrast, the protective cap for active stylus, as described above, preferably includes at least one section of the cap to be nonconductive and one other section of the cap (the writing tip) to be conductive. While the protective cap writing tip can be made of elastomer, it need not be as well. The nonconductive section of the protective cap electrically isolates the conductive body section of the stylus from the conductive cap writing tip when the protective cap is attached to the active stylus. This enables a capacitive return to earth ground with the user capacitively coupled to earth ground and the stylus body during a writing exercise. In addition, the active stylus includes detection of proximity of the ink cartridge to the cap writing tip to further enable capacitive coupling between ink cartridge and the cap writing tip.

Similarly, conventional design for passive stylus with retractable ink cartridges requires a conductive body section to be directly connected to the body's tip. This tip also needs to be made of conductive compliant material (e.g., elastomer) to be “visible” to the touchscreen upon pressing of the tip to the touchscreen surface. In addition, there is no concern over the proximity between the ink cartridge and the pen's tip.

In sharp contrast, the active stylus with retractable ink cartridge, as exemplarily described above, further includes isolating the pen's tip from the stylus' conductive body section by placing a non-conductive section in between the conductive body section and the conductive pen tip. Additionally, the active stylus includes detection of proximity of the ink cartridge to the pen writing tip to further enable capacitive coupling between ink cartridge and the pen writing tip of the retractable embodiment.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Likewise, computer-readable storage medium can comprise a non-transitory machine readable storage device, having stored thereon a computer program that include a plurality of code sections for performing operations, steps or a set of instructions.

Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An active stylus writing apparatus for writing both on a touch-sensitive interface, and paper; comprising:
a) a conductive carrier coupled on a first end of the active stylus writing apparatus, and also coupled to internal circuitry for providing an active electrically charged capacitive field to inject a sufficient capacitive charge for writing upon the touch-sensitive interface; and
b) a removable compound end cap, comprising at least two segments, the removable compound end cap configured to electrically couple to the conductive carrier when covering the conductive carrier on the first end of the active stylus writing apparatus, wherein the removable compound end cap is conductive in at least one segment and non-conductive in another segment.

2. The active stylus writing apparatus according to claim 1, further comprising an electro-conductive elastomer for causing the electrical coupling between the conductive carrier and the removable compound end cap.

3. The active stylus writing apparatus according to claim 1 further comprising an end cap tightness notification means including an audible click, a color change, and gel expansion within the removable compound end cap.

4. The active stylus writing apparatus according to claim 1, wherein the conductive carrier is configured to retain ink, lead, or light.

5. The active stylus writing apparatus according to claim 1, wherein the conductive carrier is comprised of metal or semi-conductive material.

6. The active stylus writing apparatus according to claim 1, wherein the conductive carrier is an ink cartridge and the removable compound end cap is coupled to the ink cartridge, and wherein the removable compound end cap comprises a writing tip of less than 2.5 mm.

7. The active stylus writing apparatus according to claim 1, wherein the internal circuitry in the conductive carrier is selectably controllable by covering the first end of the conductive carrier with the removable compound end cap.

8. The active stylus writing apparatus according to claim 1, wherein the touch-sensitive interface is a capacitive touchscreen.

9. In an active stylus, a method for configuring the active stylus to write on paper and an electronic touch-sensitive interface, comprising:
detecting an electric field variation with a conductive carrier configured to retain ink or pencil lead in a cartridge;
applying a gain with a circuit internal to the active stylus to a signal corresponding to the electric field variation;
injecting charge from the internal circuit of the active stylus to the cartridge; and
coupling the cartridge to a conductive segment of a removable compound end cap.

10. An active stylus writing apparatus for writing both on a touch-sensitive interface and paper; comprising:
a) a retractable conductive carrier mechanically configured to provide a paper writing tool at a first end of the active stylus writing apparatus when the retractable conductive carrier is fully extended, and also; and
b) a fixed conductive writing tip electrically coupled to to the retractable conductive carrier, of the active stylus writing apparatus, for providing an active electrically charged capacitive field to inject a sufficient capacitive charge for writing upon the touch-sensitive interface when the paper writing tool is mechanically retracted by the retractable conductive carrier.

11. The active stylus writing apparatus according to claim 10, wherein the retractable conductive carrier is configured to retain ink, lead, or light as a paper writing tool.

12. The active stylus writing apparatus according to claim 10, wherein the fixed conductive end cap is comprised of elastomer, plastic, metal, semi-conductive material, or combination thereof.

13. The active stylus writing apparatus according to claim 10, wherein the fixed conductive end cap comprises a compound writing tip less than 2.5 mm.

14. The active stylus writing apparatus according to claim 10, wherein the fixed conductive end cap further comprises a compound writing tip.

15. The active stylus writing apparatus according to claim 10, wherein the electrical coupling of the fixed conductive end cap with the internal circuitry is direct.

16. The active stylus writing apparatus according to claim 10, wherein the electrical coupling is indirect via capacitance through an ink cartridge in the retractable conductive carrier that is in contact with the internal circuitry.

17. In an active stylus, a method for configuring the active stylus to write on paper and an electronic touch-sensitive interface, comprising:
detecting an electric field variation with a conductive carrier configured to retain a pen or pencil lead in an electrically conductive cartridge; applying a gain with a circuit internal to the active stylus to a signal corresponding to the electric field variation;
injecting charge from the internal circuit of the active stylus to the electrically conductive cartridge; and
coupling the electrically conductive cartridge to a conductive tip of the pen or pencil lead.
